(19) United States
(12) Patent Application Publication
(10) Pub. No.: US 2008/0128146 A1
(43) Pub. Date: Jun. 5, 2008

(54) Rotary digging tool attachment for a hand-held power tool

(76) Inventor: Daniel Vestgard, Palm Bay, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/983,374

(22) Filed: Nov. 8, 2007

Related U.S. Application Data
(60) Provisional application No. 60/872,195, filed on Dec. 1, 2006.

(51) Int. Cl. A01B 33/04

(52) U.S. Cl. 172/111

(57) ABSTRACT

A landscaping and gardening attachment for a hand-held rotary power tool, such as a hand-held drill or weed trimmer, is provided for facilitating hole digging and the subsequent planting of vegetation. The landscaping and gardening attachment of the present invention comprises both a blade member and an elongated central shaft. The elongated central shaft is attached to the hand-held power tool at a first end of the shaft, and a second end of the shaft is secured to the blade member. The blade member may comprise a generally triangular-shaped axial cross section. In use, the blade member provides for rapid digging of planting holes, wherein the removed dirt remains about the circumference of the hole. In alternative embodiments, the hand-held power tool may be in the form of commonly owned rotary power tools, such as a weed trimmer, a hand-held power drill, a cordless screwdriver, or the like.

### CROSS REFERENCE TO RELATED APPLICATIONS

This application claims the benefit of provisional patent application Ser. No. 60/872,195, filed with the USPTO on Dec. 1, 2006, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention relates in general to the field of landscaping and gardening tools. More particularly, the present invention relates to a removable and rotatable attachment for use on a hand-held power tool, such as a weed trimmer, portable power drill, cordless screwdriver, or the like, to facilitate digging holes in soil, such as a garden or planting bed.

2. Background Art

The prior art is replete with garden tools and similar devices for digging holes in soil for setting bedding plants, bulbs and the like. The most common garden tool for digging small holes is the simple hand shovel or gardening trowel. There are significant drawbacks to the hand shovel/gardening spade. For example, it can be difficult to remove soil from the bottom of the digging hole with such a tool. Moreover, when the soil is densely packed, penetrating the soil can be laborious, requiring an excessive amount of strength and endurance. In addition, the resulting holes usually are poorly shaped and require the removal of more soil than necessary in order to set the bedding plant or bulb. An example of a typical garden trowel is illustrated by Design U.S. Pat. No. D292,865 to Scott, issued Nov. 24, 1987. More elaborate garden tools have been developed having serrated edges and/or curved ends in order to facilitate penetrating the soil, as illustrated by Design U.S. Pat. No. D352,873 to Chen, issued Nov. 29, 1994 and U.S. Pat. No. 5,765,648 to Sheehan et al., issued Jun. 16, 1998. However, the use of such garden trowels oftentimes requires excessive strength and energy, and still result in poorly formed holes.

Another type of garden tool which has been utilized for digging holes is the garden claw, characterized as having several soil-contacting fingers or prongs. Although the garden claw does facilitate penetrating the soil to some extent, it is difficult to establish a properly formed hole when using a garden claw. In addition, it is quite difficult to remove soil from the hole and the use of the garden claw requires strength and energy. Examples of modified garden claws are shown in U.S. Pat. No. 4,214,538 to Druskin et al., issued Jul. 29, 1980 and U.S. Pat. No. 5,887,283 to Mackay, issued Mar. 30, 1999.

Another type of tool used for digging in soil is the bladed garden tool. The incorporation of one or more blades facilitates the penetration of densely packed soil. Nonetheless, a good amount of strength must be used with the bladed tool, and the user can expend a great deal of energy in digging multiple holes. Moreover, such tools neither provide that the soil will be easily removed from the hole nor that the resulting holes are necessarily guaranteed to be formed any better than with the common garden trowel. Examples of bladed garden tools include U.S. Pat. No. 6,050,344 to Larson et al., issued Apr. 18, 2000 and U.S. Pat. No. 6,073,702 to Petruzzelli, issued Jun. 13, 2000.

Additionally, many power tools within the landscaping and gardening art are useful for only one purpose or task. This problem has been addressed, for example, in Aman, U.S. Pat. No. 3,554,293, issued Jan. 12, 1971, which discloses a rotary weeding and edging device, having an interchangeable shaft, for use with a hand-held, electrical power drill commonly sold for domestic use. Additionally, U.S. Pat. No. 6,615,928 to Dueitt, issued Sep. 9, 2003 discloses a powered garden tool having a rotatable digging attachment. Because electrical power drills and cordless screwdrivers are commonly owned domestic products, this type of design affords many consumers the economy of purchasing a gardening attachment independent of a power source or actuator, and at a lower price than would otherwise be possible. Effectively, consumers owning a hand-held power drill are able to avoid the cost of purchasing another power source or actuator.

Still a significant disadvantage of prior art tools such as that described in the Aman patent is that although such tools may provide attachments for performing one or two gardening functions, such functions are not diverse, thus limiting the gardening activities of the user. By way of example, the attachments described in the Aman patent permit weeding and edging, two closely related functions. Thus, to perform multiple diverse functions such as edging and hole digging, consumers have heretofore been required to purchase several tools. Accordingly, there is a need for gardening attachments capable of allowing commonly owned power tools to perform diverse types of landscaping and gardening tasks.

The availability of a landscaping and gardening attachment that is compatible with a common hand-held rotary power tool and capable of supporting many different and diverse gardening implements, would provide consumers with significant economic benefits. It would afford consumers a great economic advantage in effectively not requiring the purchase of a power source or actuator in order to purchase a power garden tool. It would also save users considerable effort in replacing the landscaping and gardening attachments, because only the attachments alone, and not the power source, would need to be removed and replaced after significant wear and use. Further, it would prevent the need for consumers to purchase several devices for performing diverse gardening activities by enabling the performance of several diverse gardening activities, such as edging and hole digging, using one gardening tool having the proper attachments.

Despite the numerous landscaping, gardening and power tools shown in the prior art and commercially available, a need still exists for a garden tool attachment that will facilitate digging holes in soil, including soil that is difficult to penetrate. Such a garden tool attachment should enable the user to plant a reasonably large quantity of bedding plants without regard to the user's strength and should require minimal effort and energy. Such a garden tool attachment also should facilitate the formation of properly shaped holes. Moreover, such a tool should be capable of removing soil from the hole, while also distributing the removed soil in a manner that expedites the soil's return once a plant is subsequently placed within the generated hole. Further, such a garden tool attachment should be capable of use when attached to commonly owned hand-held power tools, thus lowering the overall cost to the consumer. Yet further, such a garden tool should be of simple construction, inexpensive to manufacture, durable and easy to use.

Additional aspects, advantages and novel features of the present invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE INVENTION

The present invention provides for a rotatable and removable tool attachment for use with commonly owned hand-held power tools. The landscaping and gardening attachment of the present invention provides for rapid and efficient hole digging and subsequent planting of desired vegetation. The device is fast, effective, and requires very little effort to operate.

Repetitive hole digging and planting of vegetation can be a very labor intensive and time consuming process to both individual gardeners and professional landscapers alike. The present invention discloses an attachment compatible with commonly owned hand-held power tools for alleviating such an arduous task. Compatibility with commonly owned power tools serves to both lower the overall purchase cost to consumers and reduce the strenuous physical demand of manually digging and planting of vegetation.

Use of the present invention, as disclosed, quickly provides a uniform hole without much effort. Additionally, as dirt is removed from the hole being generated by the present inventive attachment, the dirt is not randomly thrown or scattered across the ground. The attachment of the present invention functions to conveniently and efficiently deposit the dirt around the immediate circumference of the hole being generated, thus greatly facilitating the process of filling in the hole after vegetation is placed therein.

The attachment of the present invention is quite simple in design, yet remains highly efficient in assisting a user in their digging and planting duties. Such a simple and efficient design can easily be produced with inexpensive and very durable components. Furthermore, such a design lends itself to ease in both its manufacture and assembly.

In accordance with a preferred embodiment of the present invention, a rotary digging tool attachment, comprising a blade member having a symmetrical polygonal shape, wherein a first arm and a second arm of the symmetrical polygonal shape are of equal length, an elongated central shaft having a first end and a second end, an attachment means disposed at the first end of the elongated shaft for removably connecting the first end of the elongated central shaft to a rotary hand-held power tool, and a securing means for fixedly securing a base surface of the blade member to the second end of the elongated central shaft.

Still other aspects and advantages of the present invention will become readily apparent to those skilled in this art from the following detailed description, wherein only the preferred embodiment of the invention is described, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a side view of one possible embodiment of the present invention.

FIG. 2 is a front view of the embodiment depicted in FIG. 1.

FIG. 3 is a bottom view of the embodiment depicted in FIG. 1 and FIG. 2.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

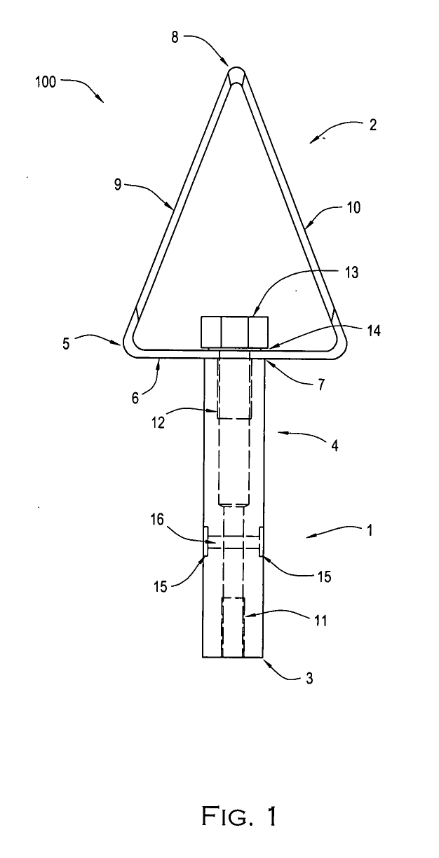

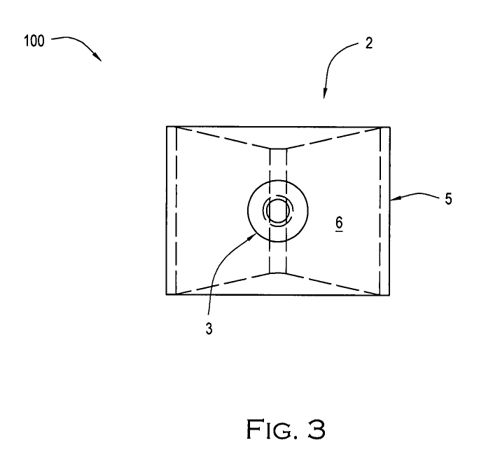

The present invention relates to a landscaping and gardening attachment for a hand-held power tool that facilitates digging holes in the ground, such as a garden or planting bed. Referring to FIGS. 1-3, the landscaping and gardening attachment 100 comprises an elongated central shaft 1 and a blade member 2, the elongated central shaft 1 having a first end 3 rotatably and detachably secured to a hand-held power tool (not shown) and a second end 4 secured to the blade member 2. Blade member 2 comprises a proximal end 5 which may have a base surface 6 and a central aperture 7, and a distal tip 8 at the intersection of a first arm 9 and a second arm 10. Both the first arm 9 and second arm 10 are connected to and extend distally from the base surface 6 of the proximal end 5, wherein the intersection of arms 9,10 forms the distal tip 8. The blade member 2 may have a generally symmetrical polygonal shape, with the preferred shape having a triangular axial cross section, as depicted in FIG. 1.

The first end 3 of the elongated central shaft 1 is rotatably and detachably secured to a hand-held power tool by an attachment means in any suitable manner as will be known to those skilled in the art. In one embodiment, shown in FIG. 1, the attachment means may be a left-handed tap 11 that is bored into first end 3 of the elongated central shaft 1, as is commonly used for attachment to the shaft of a rotary power tool. To more easily fasten such an attachment 100 embodiment to a hand-held power tool, opposing flat surfaces 15 may be milled onto the external surface of the elongated central shaft 1. With such a configuration, conventional wrenches would then be able to assist in the tightening and securing of the attachment 100 to a hand-held power tool, via communication with the opposing flat surfaces 15. Additionally and/or alternatively, a through hole 16 may be drilled through and perpendicular to the central axis of elongated central shaft 1. Through hole 16 allows for the passage of a linear implement, such as a rigid rod, shaft, or other suitably sized piece therein, in order to assist in the manual tightening and securing of the attachment 100 to a chosen hand-held power tool. Another embodiment of an attachment means for rotatably and detachably securing attachment 100 to a hand-held power tool includes, but is not limited to, the first end 3 of elongated central shaft 1 having a polygonal cross sectional configuration that is insertable and securable within a chuck of a conventional power tool. Use of both keyed and keyless chuck styles are well known within the tool arts. The elongated central shaft I may be constructed of any strong, durable material, a suitable example of which includes a metal or metal alloy compound.

The second end 4 of the elongated central shaft 1 is fastened to the base surface 6 at the proximal end 5 of the blade member 2 via a securing means in any suitable manner as will be known to those skilled in the art. In one embodiment, as depicted in FIG. 1, a securing means may be in the form of an attachment tap 12 bored into the second end 4 of the elongated central shaft 1. A bolt 13 may first be inserted through a lock washer 14; the bolt 13 may then be passed through the central aperture 7 of base surface 6; and finally the bolt 13 may be threaded into and securely fastened within attachment tap 12 in the second end 4 of the elongated central shaft 1. Another embodiment of a securing means for fastening the second end 4 of the elongated central shaft 1 to the base surface 6 at the proximal end 5 of the blade member 2 includes, but is not limited to, a welded joint and any other means of attachment known to those skilled within the art.

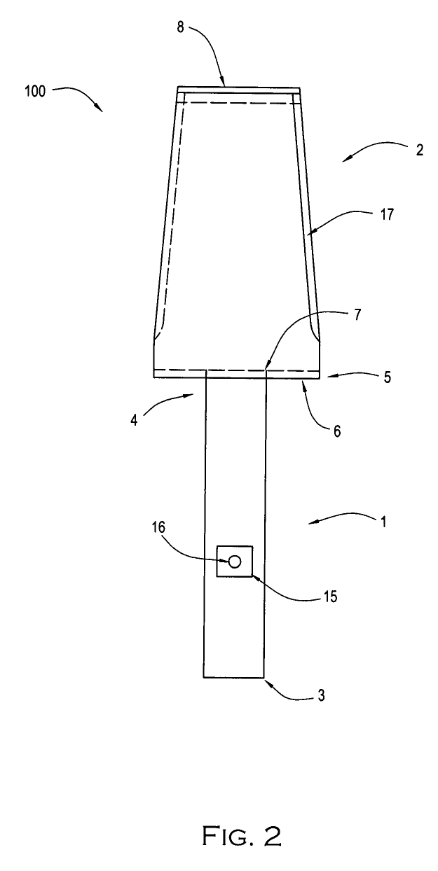

Blade member 2 comprises a base surface 6 having a central aperture 7, a first arm 9 and a second arm 10. As depicted in FIG. 1, blade member 2 generally has a triangular-shaped axial cross section. As depicted in FIG. 2, blade member 2 may be formed from a unitary molded piece or formed from at least one strip of material. The width of such material at the distal tip 8 and base surface 6 determines the diameter of the hole to be dug. When formed from a single strip of material, blade member 2 may be formed by bending the material to produce the base surface 6, and thereafter securing the ends of the strip of material together to form the distal tip 8. Attaching the ends of the strip of material together may be accomplished by any suitable manner known within the art including, but not limited to, a welded joint. Blade member 2 may also be formed from three independent strips of material that may be attached at their respective ends into a triangular shape. Additionally, distal tip 8 of blade member 2 may be flat or have a convex-shape to assist in its initial entry into the soil. Yet further, the width of the distal tip 8 of the blade member 2 may be narrower than the width of the base surface 6 to assist the attachment 100 in the entry and formation of uniform holes. The blade member 2 may be constructed of any strong, durable material, a suitable example of which includes a metal or metal alloy compound.

When rotated, the distal tip 8 of the blade member 2 functions to dig a hole where blade member 2 is pressed into contact with the ground. To assist in digging a hole in firmer soils, both the first arm 9 and second arm 10 may have the length of at least one side wall milled into a sharpened side edge 17. Depending on the direction of rotation of the attachment 100 of the present invention, only the leading soil-contacting side walls may be formed into sharpened edges 17 or, alternatively, all side walls of both the first arm 9 and second arm 10 may be formed into sharpened edges 17 allowing for both clockwise and counterclockwise rotational digging. Sharpened edge(s) 17 function to reduce the force and power required to rotate the attachment 100 of the present invention through the digging surface.

For gardeners and landscapers, digging a hole is only the first half of the work performed while planting vegetation. The soil removed from the hole must be replaced into the hole to cover the exposed roots of the vegetation deposited therein. Many hole digging prior art references remove soil well, but often haphazardly throw and scatter soil around the surface of the surrounding area. The act of planting the vegetation can then become more burdensome and laborious than if the removed soil was deposited in close proximity to the newly generated hole. The shape and structure of the attachment 100 of the present invention, such as that depicted in FIGS. 1-3, serve to assist the gardener and/or landscaper by specifically functioning to deposit soil removed from a hole around the immediate circumference of the hole. Such a function allows the act of planting to be performed in a much more efficient and rapid manner, as a user no longer has to gather loose and scattered soil from the surrounding area.

In use, the dimensions of the attachment 100 and all components of the present invention may be scaled up, or down, to accommodate the formation of larger or smaller holes. Likewise, in accordance with the size of the desired hole, the attachment may be fitted onto a wide variety of rotary hand-held power tools. For example, when a large hole is desired, a large embodiment of attachment 100 may be secured to a more powerful rotary hand-held power tool, such as an auger, to assist in removal of the inherently larger volume of soil. In a similar manner, when a small hole is desired, a small embodiment of attachment 100 may be secured to a less powerful hand-held power tool, such as a cordless screwdriver, to assist in the removal of the smaller volume of soil. In a preferred embodiment, attachment 100 is secured to a weed trimmer to assist in the rapid planting of vegetation, such as annual flowers. Attachment 100 may be fastened to any hand-held power tools known in the art including, but not limited to, a weed trimmer, a hand-held power drill, a cordless screwdriver, an auger, or the like. Power sources for such tools may include any hand-held tool power sources known within the art including, but not limited to, both gasoline and electricity (e.g. batteries, power cord, etc).

Alternatively, the rotary digging attachment 100 of the present invention may also be constructed in a less efficient manner involving manual power. Manual use of the attachment 100 of the present invention may include configurations wherein the attachment is secured to a handle, such as a T-bar shaped handle, allowing a user to manually provide the necessary rotary force for the digging process. While an attachment to a hand-held power tool is highly preferred, manual use of the attachment 100 is a viable alternative use.

While the preferred digging surface is soil within a garden or planting bed, the attachment 100 of the present invention may be utilized to assist a user in digging holes in a wide variety of possible natural and/or man-made surfaces. Such additional surfaces may include, but are not limited to, sand, clay, gravel, ice, styrofoam, and any other excavatable surfaces known within the arts.

While there is shown and described herein certain specific structures comprising aspects of the invention, it will be manifest to those skilled in the art that various modifications and rearrangements of the parts may be made without departing from the spirit and scope of the underlying inventive concept, and that the same is not limited to the particular forms herein shown and described except insofar as indicated by the scope of the claims that follow.

What is claimed is:

1. A rotary digging tool attachment, comprising:
a blade member having a symmetrical polygonal shape, wherein a first arm and a second arm of said symmetrical polygonal shape are of equal length;
an elongated central shaft having a first end and a second end;
an attachment means disposed at said first end of said elongated shaft for removably connecting said first end of said elongated central shaft to a rotary hand-held power tool; and
a securing means for fixedly securing a base surface of said blade member to said second end of said elongated central shaft.

2. The rotary digging tool attachment of claim 1, wherein said symmetrical polygonal shape comprises a triangular axial cross section.

3. The rotary digging tool attachment of claim 1, wherein each of said first arm and said second arm comprises at least one sharpened side edge.

4. The rotary digging tool attachment of claim 1, wherein said blade member further comprises a distal tip at the intersection of said first arm and said second arm.

5. The rotary digging tool attachment of claim 4, wherein said distal tip is convex-shaped to assist in initial entry of said rotary digging tool attachment into a digging surface.

6. The rotary digging tool attachment of claim 4, wherein the width of said distal tip of said blade member is narrower that the width of said base surface of said blade member.

7. The rotary digging tool attachment of claim 1, wherein said securing means comprises an attachment tap axially drilled into said second end of said elongated central shaft wherein a bolt may be passed through a central aperture within said base surface of said blade member, said bolt thereafter being threaded into and securely tightened within said attachment tap.

8. The rotary digging tool attachment of claim 1, wherein said securing means comprises a welded joint between said base surface of said blade member and said elongated central shaft.

9. The rotary digging tool attachment of claim 1, wherein said elongated central shaft further comprises at least two opposing flat surfaces about the circumference of said elongated central shaft to assist in the fastening of said elongated central shaft to said rotary hand-held power tool.

10. The rotary digging tool attachment of claim 1, wherein said elongated central shaft further comprises a through hole disposed perpendicular to the axis of said elongated central shaft for providing passage of a linear implement there through to assist in the manual tightening of said elongated central shaft to said rotary hand-held power tool.

11. The rotary digging tool attachment of claim 1, wherein said attachment means is a left-handed tap for securing said elongated central shaft to said rotary hand-held power tool.

12. The rotary digging tool attachment of claim 1, wherein said attachment means comprises a polygonal cross sectional configuration, wherein said polygonal cross sectional configuration is insertable and securable within a chuck of said rotary hand-held power tool.

13. A rotary digging tool attachment, comprising:
a blade member having a symmetrical closed triangular shape, wherein a first arm and a second arm of said symmetrical closed triangular shape are of equal length, wherein each of said first arm and said second arm comprises at least one sharpened side edge, said blade member further comprises a distal tip at the intersection of said first arm and said second arm, said distal tip comprising a convex-shaped to assist in initial entry of said rotary digging tool attachment into a digging surface;
an elongated central shaft having a first end and a second end;
an attachment means disposed at said first end of said elongated shaft for removably connecting said first end of said elongated central shaft to a rotary hand-held power tool; and
a securing means for fixedly securing a base surface of said blade member to said second end of said elongated central shaft.

14. The rotary digging tool attachment of claim 13, wherein the width of said distal tip of said blade member is narrower that the width of said base surface of said blade member.

15. The rotary digging tool attachment of claim 13, wherein said securing means is selected from the group consisting of an attachment tap axially drilled into said second end of said elongated central shaft wherein a bolt may be passed through a central aperture within said base surface and a welded joint between said base surface of said blade member and said elongated central shaft.

16. The rotary digging tool attachment of claim 13, wherein said attachment means is selected from the group consisting of a left-handed tap for securing said elongated central shaft to said rotary hand-held power tool and a polygonal cross sectional configuration insertable and securable within a chuck of said rotary hand-held power tool.

17. The rotary digging tool attachment of claim 13, wherein said elongated central shaft further comprises at least two opposing flat surfaces about the circumference of said elongated central shaft to assist in the fastening of said elongated central shaft to said rotary hand-held power tool.

18. The rotary digging tool attachment of claim 13, wherein said elongated central shaft further comprises a through hole disposed perpendicular to the axis of said elongated central shaft for providing passage of a linear implement there through to assist in the manual tightening of said elongated central shaft to said rotary hand-held power tool.

19. A rotary digging tool attachment, comprising:
a blade member having a generally triangular-shaped axial cross section, wherein a first arm and a second arm of said triangular-shaped axial cross section are of equal length and each of said first arm and said second arm comprises at least one sharpened side edge, said blade member further comprises a distal tip at the intersection of said first arm and said second arm, wherein said distal tip is convex-shaped to assist in initial entry of said rotary digging tool attachment into a digging surface;
an elongated central shaft having a first end and a second end, wherein said elongated central shaft further comprises at least two opposing flat surfaces about the circumference of said elongated central shaft to assist in the fastening of said elongated central shaft to said rotary hand-held power tool, said elongated central shaft further comprises a through hole disposed perpendicular to the axis of said elongated central shaft, wherein said through hole provides for passage of a linear implement there through to assist in the manual tightening of said elongated central shaft to said rotary hand-held power tool;
an attachment means disposed at said first end of said elongated shaft for removably connecting said first end of said elongated central shaft to a rotary hand-held power tool; and
a securing means for fixedly securing said blade member to said second end of said elongated central shaft, wherein said securing means comprises an attachment tap axially drilled into said second end of said elongated central shaft wherein a bolt may be passed through a central aperture within a base surface of said blade member, said bolt thereafter being threaded into and securely tightened within said attachment tap.

20. The rotary digging tool attachment of claim 19, wherein said attachment means is selected from the group consisting of a left-handed tap for securing said elongated central shaft to said rotary hand-held power tool and a polygonal cross sectional configuration insertable and securable within a chuck of said rotary hand-held power tool.
